(19) United States
(12) Patent Application Publication
(10) Pub. No.: US 2002/0045019 A1
(43) Pub. Date: Apr. 18, 2002

(54) Fixing label

(76) Inventors: Thomas Gassner, Heidgraben (DE); Bernhard Gebbeken, Hamburg (DE); Gunther Aster, Hamburg (DE)

Correspondence Address: KURT BRISCOE, NORRIS, MCLAUGHLIN & MARCUS, P.A., 220 EAST 42ND STREET, 30TH FLOOR, NEW YORK, NY, 10017, US

(21) Appl. No.: 09/877,621

(22) Filed: Jun. 8, 2001

(30) Foreign Application Priority Data
Jun. 14, 2000 (DE) 100 29 298.4

(51) Int. Cl. B32B 7/12; B32B 15/04; B32B 9/00; B32B 33/00

(52) U.S. Cl. 428/41.8; 428/343; 428/41.5; 428/42.2; 428/352

(57) ABSTRACT

A fixing label with an adhesive front face and a nonadhesive rear face and also two long edges for flying splice, having

a) a paper backing (F1) which is coated on one side on the front face with a self-adhesive composition (N1),

b) part of the nonadhesive rear face of the paper backing (P1) being equipped with a double-sided adhesive tape (DO) which has, on one side, a cleaving paper backing (PZ) coated on both sides with self-adhesive composition (N2, N3), wherein

c) the double-sided adhesive tape (DO) is arranged at a distance (V) of from 0.5 to 15 mm from one long edge (LK) of the adhesive tape.

The invention relates to a fixing label for flying splice (flying roll change) and also to a splicing method using such a fixing label, especially in paper converting machines, printing machines and the like.

Flying splice in papermaking plants or the like is a common technique for replacing an old, almost fully unwound roll of paper by a new roll without having to stop the machines, which run at high speed. This is done using double-sided self-adhesive tapes, known as splicing tapes, which firstly are of high adhesion and high tack but secondly, because of their water-soluble self-adhesive compositions and paper backings, do not interfere with the re-use of paper wastes in the papermaking machine. These splicing tapes are bonded skilfully in a zigzag form to the beginning of the web, a procedure requiring experienced personnel, with only about 4-5 minutes remaining for the entire procedure, owing to the high speed of the machines.

Although this technology is well established, it is not without certain disadvantages. Thus, experienced personnel are required, the procedure is intrinsically hectic, and the bonds are also relatively thick, since in each case two plies of paper and the adhesive splicing tape in between are the result: a result which is unwanted in the paper industry.

There are various products on the market, known as splicing tapes, for this “butt splicing” in flying splice, which in addition to a paper backing comprise a water-soluble self-adhesive composition coated on both sides. Adhesive tapes of this kind are marketed, inter alia, under the name tesafix (Beiersdorf).

The prior art has also described diverse adhesive tapes for such purposes. For instance, EP 418 527 A2 discloses a method of preparing a roll of printing material in web form for automatic roll changers and an adhesive strip suitable for the purpose. DE 40 33 900 A1 also describes an adhesive tape suitable for a splice. Disadvantageous, however, are sticky regions which remain exposed after splicing.

The nonadhesive masking of otherwise exposed adhesive regions is taught by U.S. Pat. No. 5,702,555 for more static loads in the securing of the start of a roll, while DE 196 32 689 A2 discloses an adhesive tape of this kind for dynamic loading during splicing, the paper backing of which tape splits and covers the adhesive compositions with its residues.

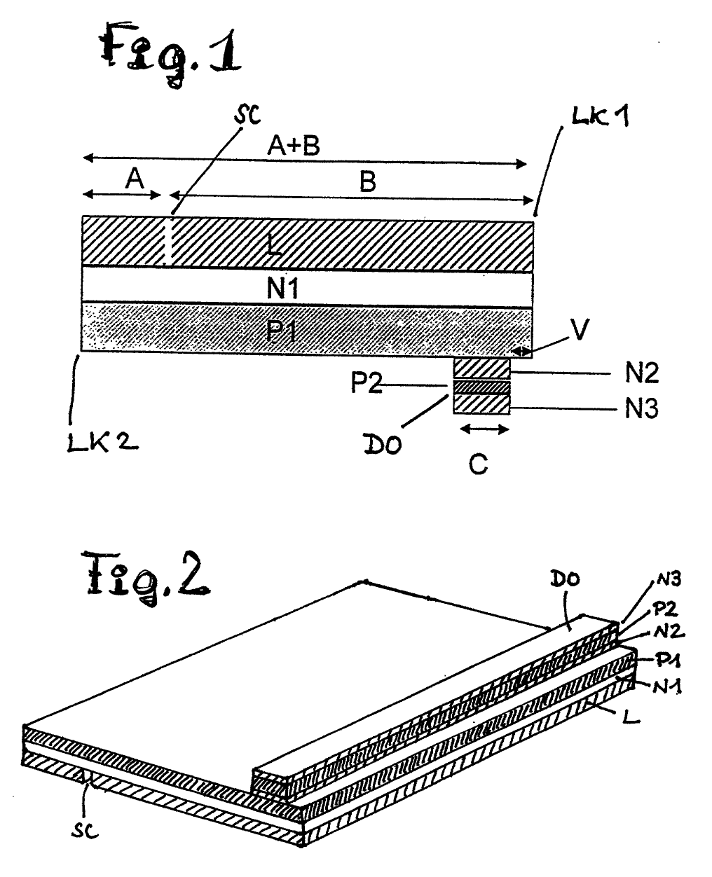

Also of this kind is an adhesive tape according to DE 196 28 317 A1, likewise for a splicing process. This adhesive tape carries on its nonadhesive reverse face a double-sided adhesive tape (6) having a readily splicing paper backing (7) splits during the splicing process (7a, 7b, FIG. 3) and masks the respective adhesives. This double-sided adhesive tape (6) is laterally flush with one side of the paper backing (2), i.e., is arranged along one of the longitudinal edges of the adhesive tape.

In practice, disadvantages become evident even with these adhesive tapes, primarily as a Pi result of the fact that a splice is not completed but instead ends as a tear, without any evident reason for this.

It was an object of the invention to remedy this situation.

This object is achieved by means of a fixing label and splicing method as detailed in the claims. In order to avoid repetition, express reference is made to the claims, in particular as regards preferred embodiments.

In accordance with the invention, splices without tears are successful, the central feature being the envisaged offset or distance V of the double-sided adhesive tape DO from the long edge LK of the fixing label. Comparative experiments set out in the table show this success over the prior art.

Cleaving Paper

The cleavable paper advantageously has a much smaller cleavage resistance than the paper backing, which has to absorb the tensile forces. A sufficient difference is useful for the functional principle of the product of the invention.

Examples of suitable cleaving papers include the following papers or paper composite systems:

Duplex papers: These papers are customary in commerce and are used, for example, in the production of filter materials and wall coverings.

Readily cleaving Papers: The cleaving energy is adjusted by way of the compaction of the paper fiber structure. The lower the degree of compaction, the lower the cleaving energy.

Suitable paper types include, for example, machine glazed uncoated papers or else supercalendered kraft papers.

Sized Paper systems: The cleaving energy is adjusted by way of the chemistry of the adhesive size. The size should not have penetrated substantially into the paper.

Clean cut edges are also helpful for the objectives of the present invention. During the cutting operation, no composition should be squeezed out. In particular, the cleavable attachment area of the cleaving material should not be covered by pressure sensitive adhesive composition.

The amount by which the cleavable material is set back, or the distance V, should in accordance with the invention be 0.5-15 mm, especially 1-7 mm, and very particularly 1.5 mm-3.5 mm.

Suitable cleaving paper comprises a variety of cleavable paper systems, such as

Duplex papers (papers laminated together in a defined manner); the cleavage procedure proceeds extremely homogeneously, no stress peaks are produced as a result, for example, of inhomogeneous compaction. These papers are used to produce wall coverings and filters.

Readily cleavable paper systems

Highly compacted papers sized together in a defined manner ( [symbol] paper with a high cleavage strength). Sizing may be carried out, for example, using starch, starch derivatives, wallpaper adhesives based on methylcellulose (Methylan®, Henkel KGaA, Dusseldorf, Germany) or else based on polyvinyl alcohol derivatives.

The width of the cleaving paper backing is preferably 3-20 mm, especially 6-12 mm.

Suitable self-adhesive compositions include all basic types of pressure sensitive adhesive composition, especially

Acrylates (water soluble and water insoluble)

Natural rubber compositions, synthetic rubber compositions

The splicing method, in this case the bonding operation using the splicing label, may take place in particular in such a way that two or more labels are bonded to the attachment, which extends at right angles to the running web (disadvantage: the cleavable paper system must cleave completely within fractions of a second), but also to an attachment which extends at an acute angle (advantage: the process of cleavage runs as a wave through the individual labels), in particular up to 25°, especially up to 15°.

The drawings show a diagram of a fastening label of the invention in cross section and in oblique plan view and are intended to illustrate the invention by way of example. The reference symbols are explained in the claims.

Considerable advantages arise over known fixing labels. Generally speaking, fixing labels have 2 functions:

A. Fixing of the top ply during the rotary acceleration of the new roll.

B. Opening of the new roll after contact with the outgoing web, by tearing open at intended breakage points.

The above-described functions of secure fixing and ready tearing are difficult to combine, since the direction of action of force is identical. Consequently, reliable fixing results in difficult tearing and conversely, easy tearing results in unreliable fixing.

The use of the fixing labels of the invention optimizes both the fixing and the opening of the topmost ply of the new roll. These fixing labels may also be subjected effectively to tensile loads, since they do not possess any intended breakage points and, instead of tearing, the label cleaves.

Because of the bonding area on the upper face of the fixing label of the invention, contact with the outgoing web directly following the pressure shaft gives rise to a force component in the z direction (radial force). The result of this force is that a specially equipped label component, bonded between the bottom label face and the periphery of the roll, cleaves and thus opens the new roll reliably (peeling process).

The special structure of the fixing label products of the invention permits independent adjustment of the necessary fixing force and tearing force.

Additionally, the bond area on the top face of the label also takes over the function of contact between outgoing web and new roll. Depending on the requirement, therefore, the demand for double-sided adhesive tapes during splicing may be reduced or may disappear entirely.

The advantages/distinguishing features of the fixing labels of the invention over presently available fixing labels are as follows:

1. Higher stability owing to the ability to take on tensile forces.

2. Splitting of the cleaving paper backing by a defined peeling process instead of tearing at intended breakage points. In this system, the directions of action of force for fixing and tearing are not identical.

3. Opening of the new roll without adhesive residues which may lead to web tears or contamination of the production equipment.

4. Additional fixing of the beginning of the roll to the outgoing web by the full-area adhesive composition on the top label face.

5. Simple and standardized geometry in rectangular form, independently of the different process requirements.

Presentation Form:

The fixing labels of the invention are advantageously wound up into a roll. By means of perforation transverse to the direction of winding, it is possible to tear off sections of predetermined length and use them as rectangular fixing labels.

An alternative to perforation is presentation by means of a dispenser having an adjustable length-setting and cutting unit. However, individual labels lined on both sides with release paper or release film are also suitable.

Other adhesive tapes from the prior art may also be used as described here in the form of individual labels in a splicing method, especially those according to DE 196 32 689 and very particularly according to DE 196 28 317.

Test methods

Measuring the Cleavage Strength of Papers

Purpose and Scope of Application

Testing the strength of paper or other fiber constructed materials in the z direction. The parameter determined is the cleavage strength.

The cleavage strength is the force which has to be overcome in order to cleave a paper element in the z direction.

Principle of the Method

Two adhesive tapes are applied to the paper to be tested, located opposite one another, and are pulled apart at an angle of 180° on a tensile testing machine. The force to be overcome in order to cleave the paper is the cleavage strength.

Instruments and Atmospheric Testing Conditions

Tensile testing machine

Blade or strip cutter 15 mm wide

Hand-held roller 2 kg

Atmospheric testing conditions: 23+/−1° C., 50+/−5% relative humidity

Materials

Adhesive tape such as testband 7475, for example width 20 mm, strips about 20 cm in length

Test Samples

DIN A 4 sheets

The samples must be conditioned for at least 16 hours under standard atmospheric conditions.

Test Procedure

Two adhesive tapes are placed on the paper to be tested from both sides, located opposite one another, and are smoothed lightly with the finger in order to avoid air inclusions.

The hand-held roller is then used to roll over the composite twice on both sides in order to achieve a satisfactory bond strength.

The bond is to be produced in such a way that, on one side, the ends of the adhesive tape project beyond the test element and, by being folded, can be stuck to each other to form a grip.

The testing direction may be the running direction or transverse to the running direction of the test element, depending on the aim of the test.

Using a steel rule, strips with a length of about 20 cm and a width of 15 mm are cut centrally from the composite. The two grips of the projecting adhesive tape are then pulled apart by hand until cleavage of the test specimen is detectable.

The test element is then clamped into the tensile testing machine by the grips, freely suspended at the top and bottom, and the rest of the strip is pulled apart at a constant speed of 300 mm/min.

In the case of very thin papers, care should be taken to ensure that the result is not falsified by the opposite edges of the adhesive tape being in contact with each other at the edge of the test element and sticking together.

Evaluation and Assessment

The cleavage strength of the paper is specified in cN/cm.

The average of 5 values determined is specified.

### Application Examples

The following examples describe trial products tried out for flying splice, the splicing conditions, and the results. The product constructions tried are illustrated in table 1.

The drawing describes the associated product construction.

Description of the Paper Systems Used:

The following coating base papers were used for the splicing trials:

[A ] Coating base paper (grammage 33 g/m², thickness 58 μm) e.g.: Stora Kabel GmbH, 58099 Hagen

[B ] Coating base paper (grammage 60 g/m², thickness 80 μm) e.g.: Stora Uetersen GmbH, 25436 Uetersen

[C ] Coating base paper (grammage 134 g/m², thickness 167 μm) e.g.: Sappi Alfeld AG, 31061 Alfeld

The following cleaving papers were used for the trial products:

[D] Duplex filter paper

Grammage 51 g/m², thickness 90 μm

Cleavage energy, transverse 34-44 cN/cm

[E] Uncoated machine glazed paper

Grammage 57 g/m², thickness 74 μm

Cleavage energy, transverse 33-38 cN/cm

[F] Supercalendered kraft paper

Grammage 50 g/m², thickness 57 μm

Cleavage energy, transverse 40-45 cN/cm

[G ] Sized paper composite system with defined cleavage energy.

Two machine calendered base papers are bonded together using a size containing starch. Grammage in each case 54 g/m², thickness 66 μm. The cleavage energy of the composite, transverse, is 28-32 cN/cm.

The following base papers were used for the trial products:

[H ] Machine calendered base paper

Grammage 54 g/m², thickness 66 μm, ultimate transverse tensile strength 40 N/15 mm

[I ] Single sidedly coated calendered base paper

Grammage 59 g/m², thickness 52 μm, ultimate transverse tensile strength 30 N/15 mm

[J] Double sidedly coated, compacted, printable decorative paper

Grammage 80 g/m², thickness 62 μm, ultimate transverse tensile strength 30 N/15 mm

[K ] Single sidedly double-coated, high-gloss chemical kraft paper

Grammage 63 g/m², thickness 51 μm, ultimate transverse tensile strength 30 N/15 mm

TABLE 1
Overview of the technical data of the trial products used and trial parameters

| | | Draw- | Exam- | Exam- | Exam- | Exam- | Exam- | Exam- | Exam- | Exam- | Exam- | Exam- | Exam- |
|---|---|---|---|---|---|---|---|---|---|---|---|---|---|
| Trial Parameters | Unit | ing | ple 1 | ple 2 | ple 3 | ple 4 | ple 5 | ple 6 | ple 7 | ple 8 | ple 9 | ple 10 | ple 11 |
| Width A + B | mm | A + B | 75 | 75 | 75 | 75 | 80 | 80 | 75 | 75 | 75 | 75 | 75 |
| Width A | mm | A | 25 | 25 | 25 | 25 | 30 | 30 | 25 | 25 | 25 | 25 | 25 |
| Width B | mm | B | 50 | 50 | 50 | 50 | 50 | 50 | 50 | 50 | 50 | 50 | 50 |
| Width C | mm | C | 12 | 12 | 12 | 12 | 9 | 9 | 6 | 9 | 9 | 9 | 9 |
| Thickness of release | μm | L | 90 | 90 | 90 | 90 | 90 | 90 | 90 | 90 | 90 | 90 | 90 |
| material 1) | | | | | | | | | | | | | |
| Release material peel | cN/cm | L | 4 | 4 | 4 | 4 | 4 | 4 | 4 | 4 | 4 | 4 | 4 |
| force 2) | | | | | | | | | | | | | |
| Amount applied to back- | g/m² | N1 | 50 | 50 | 55 | 55 | 55 | 60 | 50 | 50 | 50 | 50 | 50 |
| ing paper 3) | | | | | | | | | | | | | |
| Type of backing paper | g/m² | P1 | H | H | H | H | K | J | I | H | H | H | H |
| (type) | | | | | | | | | | | | | |
| Thickness of backing | μm | P1 | 66 | 66 | 66 | 66 | 51 | 62 | 52 | 66 | 66 | 66 | 66 |
| paper (TP) 1) | | | | | | | | | | | | | |
| Ultimate transverse ten- | N/15 | P1 | 40 | 40 | 40 | 40 | 30 | 30 | 30 | 40 | 40 | 40 | 40 |
| sile force TP 4) | mm | | | | | | | | | | | | |
| Amount applied to cleav- | g/m² | N2 | 30 | 30 | 30 | 30 | 30 | 30 | 30 | 30 | 30 | 30 | 35 |
| ing paper 3) | | | | | | | | | | | | | |
| Type of cleaving paper | g/m² | P2 | D | D | F | F | E | F | D | D | D | D | G |
| (type) | | | | | | | | | | | | | |
| Cleavage strength of | cN/cm | P2 | 34-44 | 34-44 | 40-45 | 40-45 | 33-38 | 40-45 | 34-44 | 34-44 | 34-44 | 34-44 | 28-32 |
| cleaving paper 5) | | | | | | | | | | | | | |
| Amount applied to | g/m² | N3 | 30 | 30 | 30 | 30 | 30 | 30 | 30 | 30 | 30 | 30 | 35 |
| cleaving paper 3) | | | | | | | | | | | | | |
| Offset | mm | V | 0 | 1.5 | 0 | 2 | 1 | 2 | 2 | 2 | 0 | 2 | 1.5 |
| Parameters of splicing | | | | | | | | | | | | | |
| trials | | | | | | | | | | | | | |
| Paper to be spliced (type) | g/m² | | B | B | B | B | A | B | C | B | B | C | C |
| Web speed | m/min | | 1200 | 1200 | 1200 | 1200 | 800 | 1200 | 1200 | 540 | 540 | 950 | 800 |
| Splicing angle 6) | ° | | 0 | 0 | 0 | 0 | 0 | 0 | 10 | 5 | 5 | 5 | 5 |
| Working width | cm | 100 | 100 | 100 | 100 | 100 | 100 | 100 | 100 | 160 | 160 | 375 | 100 |
| Result of the splicing | | | | | | | | | | | | | |
| trials | | | | | | | | | | | | | |
| Splicing successful | | | | X | | X | X | X | X | X | | X | X |
| Splicing failed | | | X | | X | | | | | | X | | |

1) Thickness to DIN EN 20534, d = 16 mm, 20 N
2) Peel force to FINAT FTM 3
3) Amount of adhesive composition applied to FINAT FTM 12
4) Ultimate tensile force to DIN EN ISO 1924.2 (300 mm/min, 100 mm clamped length)
5) Cleavage strength measurement method as described in the text
6) Splicing angle: right angles (= 0°) to approximately right-angled (= max 15°) to the running paper web.

1. A fixing label with an adhesive front face and a nonadhesive rear face and also two long edges for flying splice, having
a) a paper backing (F1) which is coated on one side on the front face with a self-adhesive composition (N1),
b) part of the nonadhesive rear face of the paper backing (P1) being equipped with a double-sided adhesive tape (DO) which has, on one side, a cleaving paper backing (PZ) coated on both sides with self-adhesive composition (N2, N3), wherein
c) the double-sided adhesive tape (DO) is arranged at a distance (V) of from 0.5 to 15 mm from one long edge (LK) of the adhesive tape.

2. The fixing label as claimed in claim 1, wherein the distance (V) is from 1 to 7 mm.

3. The fixing label as claimed in claim 1, wherein the distance (V) is from 1.5 to 3.5 mm.

4. The fixing label as claimed in claim 1, wherein the self-adhesive compositions (N1, N2, N3) are pressure sensitive adhesive compositions based on acrvlates or rubber.

5. The fixing label as claimed in claim 1, wherein the self-adhesive compositions (N1, N2, N3) are water soluble pressure sensitive adhesive compositions based on acrylates.

6. The fixing label as claimed in claim 1, wherein self-adhesive composition (N1) is lined with a release material (L).

7. The fixing label as claimed in claim 6, wherein the release material (L) is provided with a slit (SC).

8. The fixing label as claimed in claim 7, wherein the slit (SC) is arranged at a distance of from 15 to 40 mm from the long edge (LK2) of the fixing label which is opposite the long edge (LK1) in whose vicinity the double-sided adhesive tape (DO) is arranged.

9. The fixing label as claimed in claim 1, whose width (A+B) is 35-120 mm, especially 40-80 mm, and whose length is 35-120 mm, especially 40-80 mm.

10. The fixing label as claimed in claim 1, wherein the double-sided adhesive tape (DO) is from 3 to 20 mm, in particular from 6 to 12 mm, wide.

11. The fixing label as claimed in claim 1, wherein the cleavage strength of the paper backing (P2) is from 20 to 70 cN/cm, in particular from 22 to 60 cN/cm, very particularly from 25 to 50 cN/cm.

12. A splicing method in which at least one fixing label as claimed in any of claims 1-11 is partly stuck behind the topmost paper web of a paper roll, while the double-sided adhesive tape on the reverse face of the label is for its part stuck to the web beneath it and thereby secures the topmost paper web, first only part of the release material possibly located on the self-adhesive composition being pulled off, so that that part of the self-adhesive composition needed for the splicing method is still covered with release material and, in this state, the paper roll has no free adhesive area, after which, in order to prepare for the splicing method, any remaining release material still present is removed, whereupon the new paper roll equipped in this way is placed beside an old roll which has been almost completely unwound and is to be replaced, and is accelerated to the same rotational speed as said old roll and is then pressed against the old paper web, the exposed self-adhesive composition of the fixing label sticking to the old paper web, with substantially equal speeds of the paper webs, while at the same time the cleavable paper backing cleaves and, with its residues, nonadhesively covers both self-adhesive compositions which were coated on it.
